(19) United States
(12) Patent Application Publication
(10) Pub. No.: US 2018/0300755 A1
(43) Pub. Date: Oct. 18, 2018

(54) SEGMENTING CUSTOMERS OF EDUCATIONAL TECHNOLOGY PRODUCTS

(71) Applicant: LinkedIn Corporation, Sunnyvale, CA (US)

(72) Inventors: Sandeep Rohilla, Belmont, CA (US); He Liu, San Francisco, CA (US); Yue Li, Fremont, CA (US); Zhaoying Han, Mountain View, CA (US)

(73) Assignee: LinkedIn Corporation, Sunnyvale, CA (US)

(21) Appl. No.: 15/487,322

(22) Filed: Apr. 13, 2017

(51) Int. Cl. G06Q 30/02

(52) U.S. Cl. CPC G06Q 30/0254

(57) ABSTRACT

The disclosed embodiments provide a system for processing data. During operation, the system obtains a set of features associated with a customer, wherein the set of features includes profile data from an online professional network and one or more standardized features related to a role of the customer. Next, the system applies a set of whitelists and a set of blacklists to the features to identify a market segment for the customer. The system then uses the market segment to generate output for use in targeting the customer with an educational technology product.

### BACKGROUND

### Field

The disclosed embodiments relate to techniques for managing sales and marketing activities. More specifically, the disclosed embodiments relate to techniques for segmenting customers of educational technology products.

### Related Art

Social networks may include nodes representing entities such as individuals and/or organizations, along with links between pairs of nodes that represent different types and/or levels of social familiarity between the entities represented by the nodes. For example, two nodes in a social network may be connected as friends, acquaintances, family members, and/or professional contacts. Social networks may further be tracked and/or maintained on web-based social networking services, such as online professional networks that allow the entities to establish and maintain professional connections, list work and community experience, endorse and/or recommend one another, run advertising and marketing campaigns, promote products and/or services, and/or search and apply for jobs.

In turn, social networks and/or online professional networks may facilitate sales and marketing activities and operations by the entities within the networks. For example, sales professionals may use an online professional network to identify prospective customers, maintain professional images, establish and maintain relationships, and/or close sales deals. Moreover, the sales professionals may produce higher customer retention, revenue, and/or sales growth by leveraging social networking features during sales activities. For example, a sales representative may improve customer retention by tailoring his/her interaction with a customer to the customer's behavior, priorities, needs, and/or market segment, as identified based on the customer's activity and profile on an online professional network.

Consequently, the performance of sales professionals may be improved by using social network data to develop and implement sales strategies.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating the processing of data in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

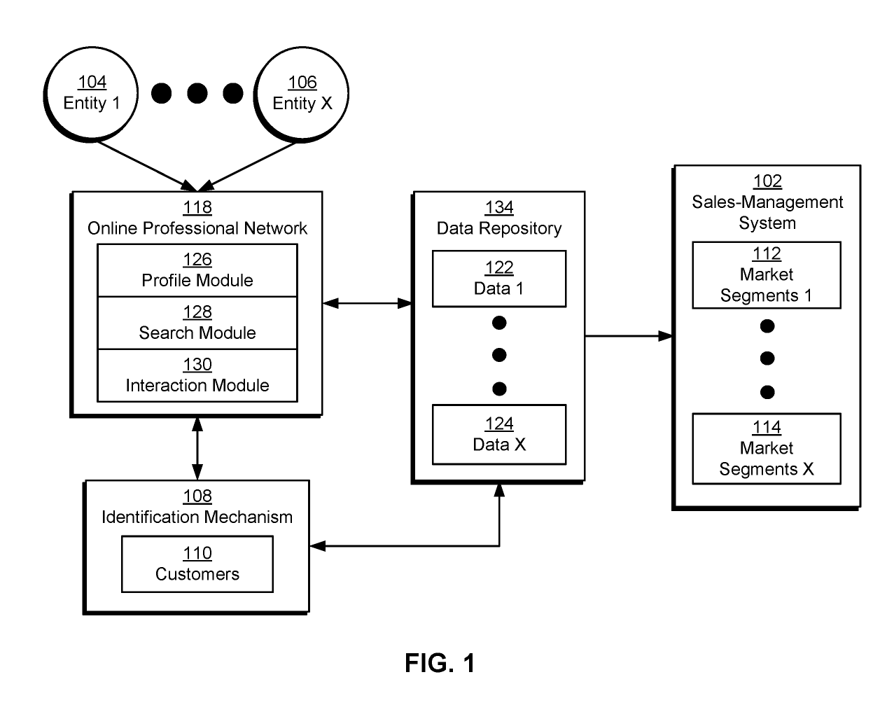

The disclosed embodiments provide a method, apparatus, and system for processing data. More specifically, the disclosed embodiments provide a method, apparatus, and system for performing segmentation of customers of educational technology products. As shown in FIG. 1, customers 110 may be members of a social network, such as an online professional network 118 or other community of users that allows a set of entities (e.g., entity 1 104, entity x 106) to interact with one another in a professional and/or business context.

The entities may include users that use online professional network 118 to establish and maintain professional connections, list work and community experience, endorse and/or recommend one another, and/or search and apply for jobs. The entities may also include companies, employers, and/or recruiters that use the online professional network to list jobs, search for potential candidates, and/or provide business-related updates to users.

The entities may use a profile module 126 in online professional network 118 to create and edit profiles containing profile pictures, along with information related to the entities' professional and/or industry backgrounds, experiences, summaries, projects, and/or skills. The profile module may also allow the entities to view the profiles of other entities in the online professional network.

Next, the entities may use a search module 128 to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature on the online professional network to search for profiles, jobs, and/or information by categories such as first name, last name, title, company, school, location, interests, relationship, industry, groups, salary, and/or experience level.

The entities may also use an interaction module 130 to interact with other entities on online professional network 118. For example, the interaction module may allow an entity to add other entities as connections, follow other entities, send and receive messages with other entities, join groups, and/or interact with (e.g., create, share, re-share, like, and/or comment on) posts from other entities. The interaction module may also allow the entity to upload and/or link an address book or contact list to facilitate connections, follows, messaging, and/or other types of interactions with the entity's external contacts.

Those skilled in the art will appreciate that online professional network 118 may include other components and/or modules. For example, the online professional network may include a homepage, landing page, and/or newsfeed that provides the entities with the latest postings, articles, and/or updates from the entities' connections and/or groups. Similarly, the online professional network may include mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, and/or other action performed by an entity in the online professional network may be tracked and stored in a database, data warehouse, cloud storage, and/or other data-storage mechanism providing data repository 134.

The entities may also include a set of customers 110 that purchase products through online professional network 118. For example, the customers may include individuals and/or organizations with profiles on the online professional network and/or sales accounts with sales professionals that operate through the online professional network. As a result, the customers may use the online professional network to interact with professional connections, list and apply for jobs, establish professional brands, purchase or use products offered through the online professional network, and/or conduct other activities in a professional and/or business context.

Customers 110 may also be targeted for marketing or sales activities by other entities in online professional network 118. For example, the customers may be companies that purchase business products and/or solutions that are offered by the online professional network to achieve goals related to hiring, marketing, advertising, and/or selling. In another example, the customers may be individuals and/or companies that are targeted by marketing and/or sales professionals through the online professional network.

As shown in FIG. 1, customers 110 may be identified by an identification mechanism 108 using data from data repository 134 and/or online professional network 118. For example, identification mechanism 108 may identify the customers by matching profile data, group memberships, industries, skills, customer relationship data, and/or other data for the customers to keywords related to products that may be of interest to the customers. Identification mechanism 108 may also identify the customers as individuals and/or companies that have sales accounts with the online professional network and/or products offered by or through the online professional network. As a result, the customers may include entities that have purchased products through and/or within the online professional network, as well as entities that have not yet purchased but may be interested in products offered through and/or within the online professional network.

Identification mechanism 108 may also match customers 110 to products using different sets of criteria. For example, the identification mechanism may match customers in recruiting roles to recruiting solutions, customers in sales roles to sales solutions, customers in marketing roles to marketing solutions, customers in learning and development roles to educational technology products, and customers in advertising roles to advertising solutions. If different variations of a solution are available, the identification mechanism may also identify the variation that may be most relevant to the customer based on the size, location, industry, and/or other attributes of the customer. In another example, products offered by other entities through online professional network 118 may be matched to current and/or prospective customers through criteria specified by the other entities. In a third example, the customers may include all entities in the online professional network, which may be targeted with products such as “premium” subscriptions or memberships with the online professional network.

After customers 110 are identified, they may be targeted with relevant products offered by or through online professional network 118. For example, marketing and/or sales professionals may use newsletters, emails, phone calls, and/or other types of communications to engage the customers with recruiting, marketing, sales, and/or advertising solutions that may be of interest to the customers. After a sales deal is closed with a given customer, a sales professional may follow up with the customer to improve the customer lifetime value (CLV) and retention of the customer.

To facilitate prioritization of marketing and/or sales activities with customers 110, a sales-management system 102 may determine one or more market segments (e.g., market segments 1 112, market segments x 114) for each customer. Each market segment may represent a group of members that share one or more common attributes. For example, market segments in online professional network 118 may be defined to include members with the same industry, location, level of seniority, and/or language. In turn, the members may be targeted and/or reached based on shared needs, preferences, interests, lifestyles, and/or demographic attributes in the corresponding member segments. As a result, attributes common to members in a given member segment may be selected based on the relevance of the attributes to features of online professional network 118 and/or products offered by or through the online professional network.

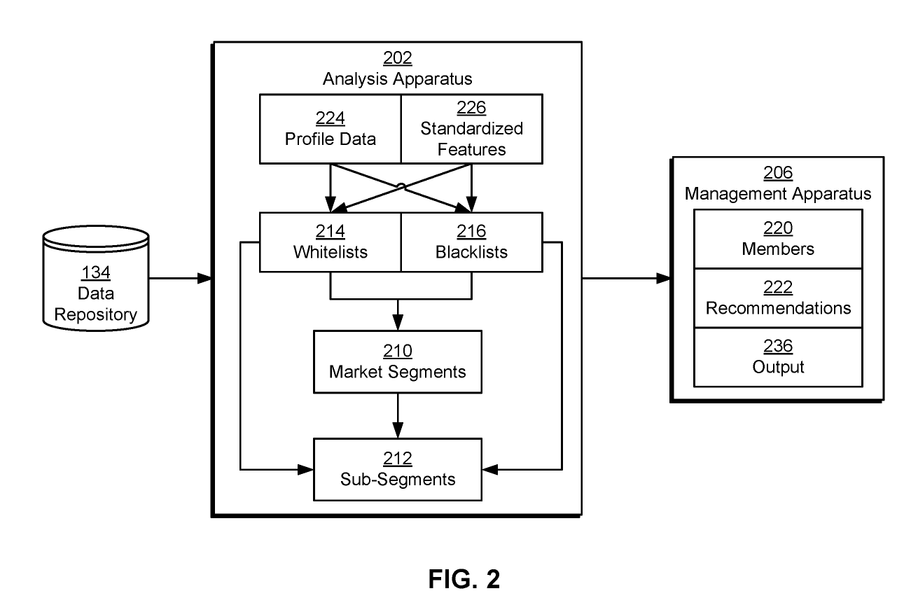

FIG. 2 shows a system for processing data in accordance with the disclosed embodiments. More specifically, FIG. 2 shows a system for generating and using a set of market segments 210 for members 220 of a social network, such as sales-management system 102 of FIG. 1. As shown in FIG. 2, the system includes an analysis apparatus 202 and a management apparatus 206. Each of these components is described in further detail below.

Analysis apparatus 202 may obtain and/or generate one or more market segments 210 for each customer of an educational technology product. As described above, the customer may be a current and/or prospective customer that is identified using data from data repository 134. Analysis apparatus 202 may also use data from data repository 134 to generate a set of features for the customer, which includes profile data 224 from the social network (e.g., online professional network 118 of FIG. 1) and a set of standardized features 226. For example, analysis apparatus 202 may use one or more queries to obtain the features directly from data repository 134, extract one or more features from the queried data, and/or aggregate the queried data into one or more features.

Profile data 224 may include fields from the customer's profile with the social network and/or data that is extracted from the fields. For example, profile data 224 may include a set of attributes for each user, such as demographic (e.g., gender, age range, nationality, location, language), professional (e.g., job title, professional summary, employer, industry, experience, skills, seniority level, professional endorsements), social (e.g., organizations of which the user is a member, geographic area of residence), and/or educational (e.g., degree, university attended, certifications, publications) attributes. The profile data may also include a set of groups to which the user belongs, the user's contacts and/or connections, and/or other data related to the user's interaction with the social network. The profile data may further include attributes that are specific to one or more features of an online professional network, such as a classification of the member as a job seeker or non-job-seeker.

Standardized features 226 may include standardized versions of one or more fields or records in profile data 224. Each standardized feature may embody a definition for the corresponding field in the profile data. For example, a standardized job function may capture what a member does at his/her company, a standardized industry may reflect the space in which the company operates, and a standardized job title may represent a job title listed on the member's resume. A standardized job title may map to multiple job functions, a single job function can encompass multiple job titles, and an individual company may belong to multiple industries. On the other hand, a standardized job title may map to a single standardized level of seniority, which may include (from highest to lowest) owner, CXO, VP, partner, director, manager, senior, entry, training, and/or unpaid.

As a result, a feature from profile data 224 may be transformed into a standardized feature and stored and/or replaced with the standardized feature in data repository 134. For example, skills and/or other attributes in the member profiles may be organized into a hierarchical taxonomy that is stored in a relational database, distributed filesystem, and/or other data storage mechanism providing the transformation repository. The taxonomy may model relationships between skills (e.g., “Java programming” is related to or a subset of “software engineering”) and/or standardize identical or highly related skills (e.g., “Java programming,” “Java development,” “Android development,” and “Java programming language” may be normalized to “Java”). The taxonomy may further be updated and/or refined based on feedback from members of the social network, such as accepting, rejecting, or ignoring recommendations of standardized attributes for inclusion in the member's profiles.

Such standardization of profile attributes may facilitate analysis of the attributes by statistical models and/or machine learning techniques, as well as use of the attributes with products in and/or associated with the social network. For example, transformation of a set of related and/or synonymous skills into the same standardized skill of “Java” may improve the performance of a statistical model that uses the skills to generate recommendations, scores, predictions, classifications, and/or other output that is used to modulate features and/or interactions in the social network. In another example, a search for members with skills that match “Java development” may be matched to a group of members with the same standardized skill of “Java,” which is returned in lieu of a smaller group of members that specifically list “Java development” as a skill. In a third example, standardization of a first company's name into the name of a second company that acquired the first company may allow a link to the first company in a member profile to be redirected to a company page for the second company in the social network.

In particular, standardized features 226 used by analysis apparatus 202 may include a standardized job title, occupation, function, and/or seniority for the customer. The standardized job title may be obtained by transforming the customer's job title or current position in his/her profile with the social network to a standardized job title. For example, words in the job title and/or position may be analyzed to identify seniority-related words, job name words, and/or function-related words; translate one or more foreign words and/or abbreviations; filter the words to obtain a set of sub-strings; and match the sub-strings to one or more standardized job titles. Each standardized job title and/or one or more words related to job function or seniority in the original job title and/or position may then be mapped to one or more standardized functions and a standardized seniority level for the customer.

The standardized occupation may represent a set of similar standardized job titles. For example, a set of standardized occupations may be generated by grouping or clustering standardized job titles by attributes such as standardized skills, job descriptions, industries, honors or awards, and/or companies. Mappings from groups of standardized job titles to standardized occupations may also be refined or modified using user feedback.

For example, a member-provided title of “sr. swe” may be converted into a standardized job title of “senior software engineer.” The standardized job title may be mapped to a standardized occupation of “software developer,” which encompasses other standardized job titles such as “java developer,” “web developer,” “developer,” “senior developer,” “java engineer,” “programmer,” and “machine learning engineer.” The standardized occupation may then be used to identify an overall standardized function of “engineering.” Finally, the “senior” keyword in the standardized job title may be used to obtain a seniority level of “senior” for the member.

After obtaining and/or generating profile data 224 and standardized features 226 for a customer, analysis apparatus 202 may apply a set of whitelists 214 and blacklists 216 to the profile data and standardized features to identify one or more market segments 210 for the customer. Each market segment may represent a type of user or role that is relevant or related to educational content, tools, or features provided with the educational technology product. For example, the market segments may relate to technology leaders, information technology (IT), software development, data science, human resources, higher education, creative roles (e.g., designers, artistic directors, artists, etc.), computer aided design (CAD), government, and/or learning and development.

After the customer is placed into one or more market segments 210, analysis apparatus 202 may optionally use one or more additional whitelists 214 and/or blacklists 216 to identify one or more sub-segments 212 of the market segments to which the customer belongs. Continuing with the previous example, the higher education market segment may include sub-segments related to academic affairs, academic technologies, administration, career services, communications, deans or chairs, faculty, library, and student affairs. The government market segment may include sub-segments representing library, administration, and communication roles.

Each whitelist or blacklist may pertain to a specific type of feature in profile data 224 and/or standardized features 226. As a result, the customer may be added to a given market segment when a value of a particular type of feature for the customer is found in the corresponding whitelist for the market segment. When the market segment has multiple whitelists for different types of customer features (e.g., occupation, job title, industry, seniority, etc.), the customer's inclusion in or exclusion from the market segment may be determined by applying a logical conjunction or logical disjunction to results of comparing the customer's features to the whitelists. For example, the customer may be included in a given market segment if either the customer's occupation or job title is found in the corresponding whitelist for the market segment. Alternatively, a market segment may be defined to require the inclusion of both the customer's occupation and job title in the corresponding whitelists. If the same feature is found in multiple whitelists for different market segments, a customer with that feature may be added to the market segments, as long as other features of the customer meet other requirements associated with each of the market segments.

Conversely, the customer may be excluded from a given market segment if any of the customer's features is found in any blacklists for the market segment. Continuing with the previous example, the customer may be excluded from the market segment if the customer's occupation or job title is included in the corresponding blacklists for the market segment.

Customers in an IT market segment may be identified using a whitelist of standardized occupations that include, but are not limited to, “ERP Consultant,” “Information Security Specialist,” “Information Technology Auditor,” “Information Technology Consultant,” “Information Technology Engineer,” “Information Technology Support Specialist,” “Information Technology System Administrator,” “Network Engineer,” “Telecommunications Specialist,” “Technical Support Representative,” and “Chief Information Officer.” The market segment may also, or instead, be defined using a whitelist of standardized job titles that include, but are not limited to, “Security,” “Networking and Systems Admin,” “Cloud Administrator,” “Data Management,” “Information Security Specialist,” “Technical Support Representative,” “IT System Administrator,” “Network Administrator,” “Network Engineer,” “Database Administrator,” “System Deployment Specialist,” “IT Security Specialist,” “Network Architect,” “Linux System Administration,” “Cloud Computing,” “Cybersecurity,” “Help Desk Administrator,” “Help Desk Manager,” “IT Director,” “IT Manager,” “IT Techniciation,” “Systems Administrator,” and “Devops.”

A software development market segment may be defined using a whitelist of standardized occupations that include, but are not limited to, “Chief Information Officer,” “Chief Technology Officer,” “Embedded Software Engineer,” “Quality Assurance Tester,” “Software Developer,” “Software Tester,” “Test Development Engineer,” and “Website Manager.” Customers in the market segment may also, or instead, be identified using a whitelist of standardized job titles that include, but are not limited to, “Mobile Development,” “Web Development,” “Full-Stack Web Developer,” “Backend Web Developer,” “Frontend Web Developer,” “Developer,” “Programmer,” “Full-Stack Developer,” “Site Maintainer,” “Director of Technology,” “Devops,” “Head of Technology and Online Services,” “Emerging Technologies Manager,” “Systems Analyst,” “Webmaster,” “Program Manager,” and “Technical Services Manager.” Because the “Devops” job title is found in whitelists for both the software development and IT market segments, a customer with that job title may be included in both market segments.

Customers in a data science market segment may be identified using a whitelist of standardized occupations that include, but are not limited to, “Database Developer,” “Data Analyst,” and “Data Center Manager.” The data science market segment may also, or instead, be defined using a whitelist of standardized job titles that include, but are not limited to, “Data Scientist,” “Data Analyst,” “Data Architect,” “Data Engineer,” “Statistician,” “Database Administrator,” “Data and Analytics Manager,” “Data Visualization,” “Database Manager,” and “Chief Data Officer.”

A technology leaders market segment may include customers in the IT, software development, and/or data science market segments. The market segment may further be defined by a whitelist of standardized seniorities that includes CXO, Director, Manager, Owner, Partner, Senior, and VP. Thus, the market segment may include customers in leadership and/or management positions instead of in non-management or lower-level positions.

A market segment for creative roles may include a whitelist of standardized occupations that include, but are not limited to, “3D Artist,” “3D Designer,” “Advertising Specialist,” “Animator,” “Architect,” “Arts Professional,” “Audio-Visual Specialist,” “Computer Aided Designer,” “Creative Designer,” “Fashion Designer,” “Game Designer,” “Illustrator,” “Industrial Designer,” “Interior Designer,” “Landscape Designer,” “Marketing Creative Designer,” “Motion Graphics Designer,” “Multimedia Specialist,” “Photographer,” “Print Specialist,” “User Experience Designer,” “Web Designer,” and “Website Manager.” The market segment may also, or instead, be defined using a whitelist of standardized job titles that include, but are not limited to, “Art Director,” “Artist,” “Audio Engineer,” “Author,” “Creative Director,” “Design Manager,” “Freelance Designer,” “Graphic Artist,” “Graphic Designer,” “InDesign,” “Interactive Developer,” “Interaction Designer,” “Motion Graphics Designer,” “Photo Editor,” “Print Production,” “Production Artist,” “UI Designer,” “UX Designer,” “User Experience Researcher,” “User Interface Designer,” “Video Editor,” “Videographer,” and “Webmaster.” Customers with standardized occupations and/or job titles that match one or both whitelists may be subjected to an additional whitelist of standardized seniorities that includes CXO, Director, Manager, Owner, Partner, Senior, and VP. As with the technology leaders market segment, the seniority-based whitelist may be used to restrict the creative market segment to customers with relatively senior roles.

A human resources market segment may be defined using a whitelist of standardized occupations that include, but are not limited to, “Corporate Trainer” and “Human Resources Specialist.” The market segment may also, or instead, include a whitelist of standardized job titles that include, but are not limited to, “VP of HR,” “Director of HR,” and “HR Manager.” As with the technology leaders and creative market segments, customers in the human resources market segment may be filtered to include the seniorities of CXO, Director, Manager, Owner, Partner, Senior, and VP. The human resources market segment may further include a blacklist that excludes customers in the learning and development market segment from inclusion in the human resources market segment.

A learning and development market segment may include a whitelist and a blacklist of non-standardized job titles. Items in the whitelist may include, but are not limited to, “Learning and Development,” “Learning,” “Training,” “Corporate Learning,” “Leadership Development,” “E-Learning,” “Online Learning,” “Corporate Trainer,” “Organizational Development,” “Chief Talent Officer,” “Sales Effectiveness,” “Professional Development,” “Chief Learning Officer,” “CLO,” and/or “CHRO.” Items in the blacklist may include, but are not limited to, “Athletic Trainer,” “Athletic Training,” “Machine Learning,” “Pet Trainer,” “Pet Training,” “Dog Trainer,” “Dog Training,” “Horse Trainer,” “Horse Training,” “Corporate Development,” “Fitness Trainer,” “Fitness Training,” and “Business Development.” Customers in the market segment may also, or instead, be identified using a whitelist of standardized job titles that include, but are not limited to, keywords such as “learning,” “career,” “coach,” “training,” “trainer,” “development,” “e-learning,” “instruction,” and/or “education.” The market segment may additionally, or alternatively, include a whitelist of standardized occupations that include, but are not limited to, “Career Counselor,” “Corporate Trainer,” “Instructional Designer,” and/or “Technology Instructor.”

A CAD market segment may be defined using a whitelist of standardized titles that include, but are not limited to, “Automotive Engineer,” “Electrical Engineer,” “Facilities Manager,” “Manufacturing Operations Manager,” “Marine Engineer,” “Mining Engineer,” “Petroleum Drilling Engineer,” “Piping Designer,” “Piping Engineer,” “Product Development Engineer,” “Surveyor,” “Transportation Engineer,” “Transportation Planner,” “Urban Planner,” “Manufacturing Engineer,” “Mechanical Engineer,” “Computer Aided Designer,” “Architect,” “Structural Engineer,” “Interior Designer,” “Industrial Designer,” “Graphic Designer,” “Urban Designer,” “Urban Planner,” and “Civil Engineer.” The market segment may also, or instead, be defined using a whitelist of standardized occupations that include, but are not limited to, “Engineer,” “Hardware Engineer,” “Civil Engineer, “Transportation Specialist,” “Construction Project Planner,” “Information Technology Consultant,” and “Civil Engineer.”

A higher education market segment may include customers in the learning and development, human resources, and/or IT market segments. The customers may be filtered to include only senior roles such as CXO, Director, Manager, Owner, Partner, Senior, and VP. The market segment may also, or instead, include one or more whitelists. The whitelists may identify standardized occupations such as “Instructional Designer” and “Education Administrator,” a standardized industry of “Higher Education,” and/or standardized job titles of “Manager of Instructional Design,” “Manager of Curriculum Development,” “Library Director,” “Manager of Electronic Resources,” “Manager of Electronic Databases,” “Manager of Curriculum Development,” “Director of Distance Learning,” “Director of Extension Program,” “Director of Career Services,” “Systems Librarian,” “Dean of Schools,” “Department Chair,” “Dean of Library,” “Assistant Dean of Library,” “Head of Library Services,” “Academic Counselor,” and “Faculty.” Standardized occupations and/or job titles may further be grouped into whitelists for sub-segments representing academic affairs, academic technologies, administration, career services, communications, deans or chairs, faculty, library, and student affairs.

A government market segment may include a whitelist of standardized industries such as “Government Administration” and “Military,” as well as a whitelist of employers containing names of government agencies. The market segment may include customers that have standardized and/or non-standardized job titles from the learning and development, human resources, technology leaders, and/or creative market segments. The market segment may have additional whitelisted job titles, such as “Training & Development Officer,” “Chief Innovation Officer,” and “SEO Specialist.”

Sub-segments of the government market segment may include library, administration, and communications. The library sub-segment may have a whitelist of standardized job titles that include, but are not limited to, “Library Director,” “Library Manager,” “Collection Development,” “Head of Reference,” “Head of Audit Services,” “Emerging Technologies Librarian,” “Emerging Technologies Manager,” “Digital Services Librarian,” “Systems Librarian,” “Digital Librarian,” “Digital Collections Manager,” “Library Services Manager,” and “Library Services Director.” The communications sub-segment may have a whitelist of standardized job titles that include, but are not limited to, “Communications Director,” “Communications Manager,” “Web Manager,” “Marketing Manager,” “Marketing Director,” “Content Strategist,” and “Web Content Strategist.”

The administration sub-segment may have additional sub-sub-segments of finance, administration, operations, and procurement. The finance sub-sub-segment may be defined by whitelisted standardized job titles such as “CFO,” “Director of Finance,” “Finance Manager,” “Business Analyst,” and “Finance Analyst.” The administration sub-sub-segment may include whitelisted standardized job titles such as “CEO,” “Business Analyst,” “Analyst,” and “Project Manager.” The operations sub-sub-segment may have a whitelist of standardized job titles that include, but are not limited to, “COO,” “Operations Director,” “Operations Manager,” “Operations Analyst,” and “Project Manager.” The procurement sub-sub-segment may have a whitelist of standardized job titles that include, but are not limited to, “Procurement Manager,” “Purchasing Manager,” “Purchasing Agent,” and “Purchaser.”

After market segments 210 and sub-segments 212 are identified for current and/or prospective customers of the educational technology product, management apparatus 206 may use the market segments and/or sub-segments to manage sales and/or marketing activity with the customers. First, the management apparatus may output lists of members 220 in each market segment and/or sub-segment. For example, the management apparatus may display and/or export the lists in a user interface, table, spreadsheet, database, and/or other format. The management apparatus may also enable filtering of the lists by other attributes of the customers, such as seniority, location, industry, company, and/or metrics or scores related to their potential as sales leads, current or projected purchase behavior, and/or other sales-related behavior with respect to the educational technology product and/or other products (e.g., marketing solutions, sales solutions, talent solutions, etc.) offered through the online professional network.

Management apparatus 206 may also generate a set of recommendations 222 associated with the customers. For example, the management apparatus may recommend targeting of the customers with marketing and/or sales strategies that are tailored to market segments 210 and/or sub-segments 212 of the customers. In another example, the management apparatus may generate recommendations for customizing the product experience of a customer based on the customer's market segments and/or sub-segments. In a third example, the management apparatus may generate, for each customer, a list of “top courses” from the educational technology product that are popular, highly rated, and/or highly relevant to the customer's market segments.

Management apparatus 206 may further generate output 236 for targeting the customers with the educational technology product based on market segments 210 and/or sub-segments 212. For example, the management apparatus may transmit a weekly marketing email for the educational technology product to customers of one or more market segments and/or sub-segments. For each market segment or sub-segment, the management apparatus may include a campaign and/or promotional offer in the marketing email that is more likely to be relevant or appealing to the market segment or sub-segment than a generic trial offer for the educational technology product. In another example, the management apparatus may generate a product experience for acquiring customers in the learning and development market segment using webinars with existing learning and development customers, recommendations for using the educational technology product to meet the customers' learning and development goals, and/or providing a list of top courses for meeting the customers' learning and development goals. In a third example, the management apparatus may contact a customer in a non-management role and the IT market segment with a free trial of the educational technology product and a list of highly rated or popular courses for the IT market segment. Consequently, the system of FIG. 2 may improve marketing or sales of products through the online professional network by identifying and targeting customers based on market segments that are relevant to various use cases of the educational technology product.

Those skilled in the art will appreciate that the system of FIG. 2 may be implemented in a variety of ways. First, analysis apparatus 202, management apparatus 206, and/or data repository 134 may be provided by a single physical machine, multiple computer systems, one or more virtual machines, a grid, one or more databases, one or more filesystems, and/or a cloud computing system. Analysis apparatus 202 and management apparatus 206 may additionally be implemented together and/or separately by one or more hardware and/or software components and/or layers.

Second, profile data 224, standardized features 226, and/or other data used to produce member segments 210 and/or sub-segments 212 may be obtained from a number of data sources. For example, data repository 134 may include data from a cloud-based data source such as a Hadoop Distributed File System (HDFS) that provides regular (e.g., hourly) updates to data associated with connections, activity with the online professional network, and/or activity with marketing material. Data repository 134 may also include data from an offline data source such as a Structured Query Language (SQL) database, which refreshes at a lower rate (e.g., daily) and provides data associated with profile content (e.g., profile pictures, summaries, education and work history), profile completeness, and/or metrics or scores calculated using statistical models. Data repository 134 may further include data from external systems, such as customer relationship management (CRM) and/or sales-management platforms.

Third, a variety of techniques may be used to generate member segments 210 and/or sub-segments 212. For example, whitelists 214 and/or blacklists 216 may be provide in configuration files instead of hardcoded rules. In turn, the configuration files may allow member segments and/or sub-segments to be dynamically added, removed, and/or modified for subsequent use in targeting customers of the educational technology product. In another example, one or more member segments and/or sub-segments may be generated using statistical models such as artificial neural networks, Bayesian networks, support vector machines, clustering techniques, regression models, and/or random forests.

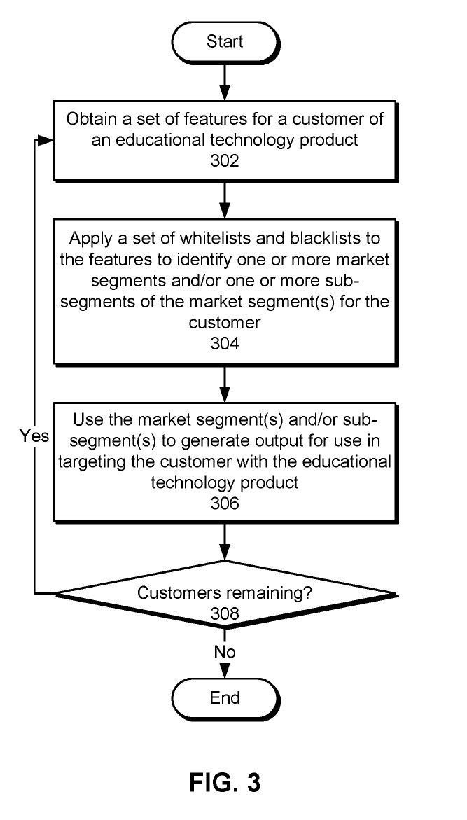

FIG. 3 shows a flowchart illustrating the processing of data in accordance with the disclosed embodiments. More specifically, FIG. 3 shows a flowchart of segmenting customers of an educational technology product. In one or more embodiments, one or more of the steps may be omitted, repeated, and/or performed in a different order. Accordingly, the specific arrangement of steps shown in FIG. 3 should not be construed as limiting the scope of the embodiments.

Initially, a set of features is obtained for a new or prospective customer of the educational technology product (operation 302). The features may include profile data from an online professional network and/or one or more standardized features related to a role of the customer. The profile data and/or standardized features may include an occupation, job title, industry, function, employer, seniority, and/or industry for the customer.

Next, a set of whitelists and a set of blacklists are applied to the features to identify one or more market segments and/or one or more sub-segments of the market segment(s) for the customer (operation 304). For example, each market segment may be defined using one or more whitelists and/or blacklists for standardized and/or non-standardized occupations, job titles, seniorities, industries, and/or other features related to the customer. After the customer is placed into a given market segment, additional whitelists and/or blacklists may be used to further identify any sub-segments of the market segment to which the customer belongs.

Finally, the market segment(s) and/or sub-segment(s) are used to generate output for use in targeting the customer with the educational technology product (operation 306). For example, a product experience of the customer with the educational technology product may be tailored to the market segment(s) and/or sub-segment(s). In another example, the customer may be targeted with a set of top courses in the educational technology product for the market segment(s) and/or sub-segment(s). In a third example, the customer may be targeted with a marketing communication (e.g., email, newsletter, message, promotional offer, etc.) containing content that is relevant to the market segment. Operations 302-306 may be repeated for remaining customers (operation 308) of the educational technology product, which may include new and/or prospective customers of the educational technology product.

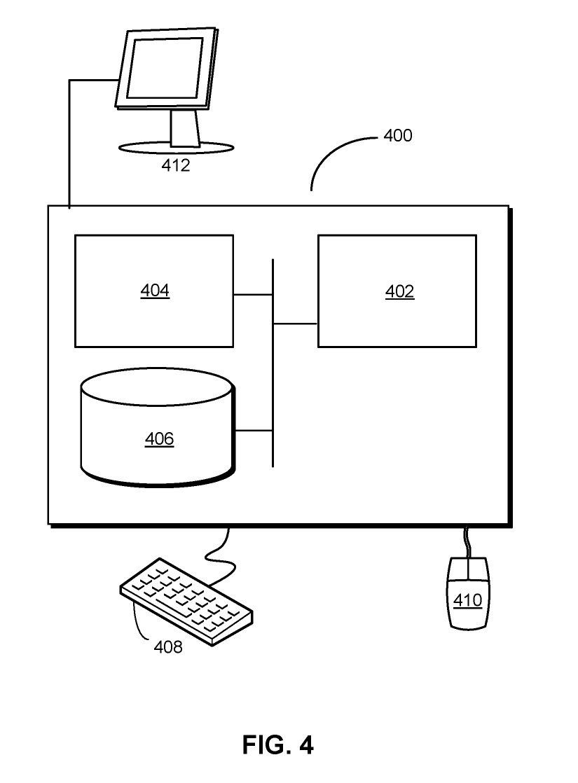

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for processing data. The system may include an analysis apparatus and a management apparatus, one or both of which may alternatively be termed or implemented as a module, mechanism, or other type of system component. The analysis apparatus may obtain a set of features associated with a customer, including profile data for the customer from an online professional network and one or more standardized features related to a role of the customer. Next, the analysis apparatus may apply a set of whitelists and a set of blacklists to the features to identify a market segment for the customer. The management apparatus may then use the market segment to generate output for use in targeting the customer with an educational technology product.

In addition, one or more components of computer system 400 may be remotely located and connected to the other components over a network. Portions of the present embodiments (e.g., analysis apparatus, management apparatus, data repository, etc.) may also be located on different nodes of a distributed system that implements the embodiments. For example, the present embodiments may be implemented using a cloud computing system that identifies a set of market segments for a set of remote customers of an educational technology product.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a set of features associated with a customer, wherein the set of features comprises profile data from an online professional network and one or more standardized features related to a role of the customer;
applying, by one or more computer systems, a set of whitelists and a set of blacklists to the features to identify a market segment for the customer; and
using the market segment to generate, by the one or more computer systems, output for use in targeting the customer with an educational technology product.

2. The method of claim 1, further comprising:
applying the whitelists and the blacklists to the features to identify a sub-segment of the market segment for the customer; and
modifying the output based on the sub-segment.

3. The method of claim 1, further comprising:
using the whitelists and the blacklists to identify an additional market segment for the customer; and
modifying the output based on the additional market segment.

4. The method of claim 1, wherein applying the set of whitelists and the set of blacklists to the features to identify the market segment for the customer comprises:
when a feature in the set of features is found in a whitelist in the set of whitelists, including the customer in a first market segment represented by the whitelist; and
when the feature is found in a blacklist in the set of blacklists, excluding the customer from a second market segment represented by the blacklist.

5. The method of claim 1, wherein using the market segment to generate output for use in targeting the customer with the educational technology product comprises:
tailoring a product experience of the customer with the educational technology product to the market segment.

6. The method of claim 1, wherein using the market segment to generate output for use in targeting the customer with the educational technology product comprises:
targeting the customer with a set of top courses for the market segment in the educational technology product.

7. The method of claim 1, wherein using the market segment to generate output for use in targeting the customer with the educational technology product comprises:
targeting the customer with a marketing communication that is relevant to the market segment.

8. The method of claim 1, wherein the set of features comprises:
an employer;
a seniority;
a headline; and
an industry.

9. The method of claim 1, wherein the one or more standardized features comprise:
a job title; and
an occupation representing a set of related job titles.

10. The method of claim 1, wherein the market segment represents at least one of:
learning and development;
technology leaders;
information technology (IT);
software development;
data science;
human resources;
higher education;
creative roles;
computer aided design; and
government roles.

11. An apparatus, comprising:
one or more processors; and
memory storing instructions that, when executed by the one or more processors, cause the apparatus to:
obtain a set of features associated with a customer, wherein the set of features comprises profile data from an online professional network and one or more standardized features related to a role of the customer;
apply a set of whitelists and a set of blacklists to the features to identify a market segment for the customer; and
use the market segment to generate output for use in targeting the customer with an educational technology product.

12. The apparatus of claim 11, wherein the memory further stores instructions that, when executed by the one or more processors, cause the apparatus to:
apply the whitelists and the blacklists to the features to identify a sub-segment of the market segment for the customer; and
modify the output based on the sub-segment.

13. The apparatus of claim 11, wherein the memory further stores instructions that, when executed by the one or more processors, cause the apparatus to:
use the whitelists and the blacklists to identify an additional market segment for the customer; and
modify the output based on the additional market segment.

14. The apparatus of claim 11, wherein applying the set of whitelists and the set of blacklists to the features to identify the market segment for the customer comprises:
when a feature in the set of features is found in a whitelist in the set of whitelists, including the customer in a first market segment represented by the whitelist; and
when the feature is found in a blacklist in the set of blacklists, excluding the customer from a second market segment represented by the blacklist.

15. The apparatus of claim 11, wherein using the market segment to generate output for use in targeting the customer with the educational technology product comprises at least one of:
tailoring a product experience of the customer with the educational technology product to the market segment;
targeting the customer with a set of top courses for the market segment in the educational technology product; and
targeting the customer with a marketing communication that is relevant to the market segment.

16. The apparatus of claim 11, wherein the set of features comprises:
an employer;
a seniority;
a headline; and
an industry.

17. The apparatus of claim 11, wherein the one or more standardized features comprise:
a job title; and
an occupation representing a set of related job titles.

18. The apparatus of claim 11, wherein the market segment represents at least one of:
learning and development;
technology leaders;
information technology (IT);
software development;
data science;
human resources;
higher education;
creative roles;
computer aided design; and
government roles.

19. A system, comprising:
an analysis module comprising a non-transitory computer-readable medium storing instructions that, when executed, cause the system to:
obtain a set of features associated with a customer, wherein the set of features comprises profile data from an online professional network and one or more standardized features related to a role of the customer; and
apply a set of whitelists and a set of blacklists to the features to identify a market segment for the customer; and
a management module comprising a non-transitory computer-readable medium storing instructions that, when executed, cause the system to use the market segment to generate output for use in targeting the customer with an educational technology product.

20. The system of claim 19, wherein the non-transitory computer-readable medium of the analysis apparatus further stores instructions that, when executed, cause the system to:
apply the whitelists and the blacklists to the features to identify a sub-segment of the market segment and an additional market segment for the customer; and
modify the output based on the sub-segment and the additional market segment.
